(19) United States
(12) Patent Application Publication
(10) Pub. No.: US 2014/0185021 A1
(43) Pub. Date: Jul. 3, 2014

(54) IMAGE DISPLAYING DEVICE

(71) Applicant: Funai Electric Co., Ltd., Osaka (JP)

(72) Inventor: Daisuke Yamagiwa, Osaka (JP)

(73) Assignee: Funai Electric Co., Ltd., Osaka (JP)

(21) Appl. No.: 14/046,219

(22) Filed: Oct. 4, 2013

(30) Foreign Application Priority Data
Dec. 27, 2012 (JP) 2012-283820

(51) Int. Cl. G03B 21/28

(52) U.S. Cl. CPC G03B 21/28
USPC 353/99; 353/98; 353/121

(57) ABSTRACT

An image projecting device includes a light-emitting element that emits a laser beam and is secured to a housing and a mirror element adjustably disposed on the housing and that reflects the laser beam emitted from the light-emitting element to be directed to a position that has been determined to be a focusing target. The mirror element is adjustable while being disposed on the housing.

### FIELD OF TECHNOLOGY

The present invention relates to an image displaying device for displaying a color image by combining a plurality of laser beams of different color components.

### BACKGROUND ART

As typified by a laser projector, for example, various types of image displaying devices for displaying a color image on a projection plane through combining, and projecting onto a projection plane, laser beams of a red color component (R), a green color component (G), and a blue color component (B) have been commercialized.

Moreover, various inventions have been proposed relating to such projection-type image displaying devices.

For example, Patent Citation 1 discloses an invention having a beam source portion for generating beam of a plurality of different colors, modulated based on an image signal, a color mixing portion for mixing the plurality of colored beams from the beam source portion, onto an identical axis, a beam scanning portion for deflecting the combined beam, combined by the color combining portion, in two-dimensional directions in response to an image signal, and a plurality of optical planes of non-rotating object shapes, wherein the beam scanning portion is equipped with a free-form-surface prism for magnifying at least a deflection angle and emitting the combined beam that has been deflected by the beam scanning portion, to display an image through the combined beam projected from the free free-form-surface prism.

For example, Patent Citation 2 discloses an invention wherein the housing of an image forming device expands due to heat produced from a laser beam source disposed in proximity to the housing, but the wall thickness of a wall thickness portion of the housing is thinner the further away from the laser beam source, and thus even if the housing expands, the expansion of the wall thickness portion in the vicinity of the dichroic mirror disposed on the housing is prevented, so that the position of the dichroic mirror does not change

For example, Patent Citation 3 discloses an invention that is a beam forming prism for combining, onto an identical axis, the respective beams emitted from first through third beam sources, and for performing beam forming, having first through third diffracting faces into which the respective emitted beams are incident, a first optical axis combining face for producing a first combined beam by combining, onto the same axis, the emitted beam from the first diffraction face and the emitted beam from the second diffraction face, a second optical axis combining face for producing a second combined beam by combining onto the same axis the first combined beam and the emitted beam from the third diffraction face, and a fourth diffraction face for diffracting and emitting the second combined beam, wherein, of the first through third diffraction faces, at least one diffraction face is the same face as the first or second optical axis combining face.

### PRIOR ART CITATIONS

### Patent Citations

[Patent Citation 1] Japanese Unexamined Patent Application Publication 2009-288520

[Patent Citation 2] Japanese Unexamined Patent Application Publication 2011-64926

[Patent Citation 3] Japanese Unexamined Patent Application Publication 2011-197217

For example, in a laser projector, laser beams of the individual color components emitted from a plurality of beam emitting elements are cause focused at a specific position (an aperture, a scanning mirror, or the like) using a variety of optical elements (such as lenses, minors, and prisms). In this case, it is necessary to adjust the optical axis and to adjust the brightness of each laser beam so that each individual laser beam will be focused correctly.

The adjustments to laser beams, using a conventional approach, will be explained here, referencing FIG. 18.

In the laser projector 21 illustrated in FIG. 18, three laser diodes (LDs) 22a through 22c, for emitting laser beams of different color components, are disposed in parallel. The laser beams emitted from LDs 22a through 22c pass through lenses 23a through 23c, corresponding to the respective color components, to be formed into parallel beams, and are emitted toward dichroic mirrors 24a through 24c. The dichroic mirrors 24a through 24c each has the property of reflecting the laser beam of the corresponding color component and passing the others, and are disposed so that the laser beams that are incident on the individual lenses will be emitted toward the same optical axis (will be combined). The beam combined through the dichroic minors 24a through 24c, is directed toward a scanning mirror 28, passing sequentially through two prisms 25a and 25b, an aperture 26, and a reflecting mirror 27 to be emitted from the scanning mirror 28 toward an external projection plane while undergoing scanning dislocation. These components 22 through 28 are supported by or disposed on a housing 30 in a specific arrangement.

In the conventional approach, the structure has been one wherein one or all of the LDs 22a through 22c, which are the light-emitting elements, has the position thereof adjusted in order to cause the laser beams of the individual color components to be focused onto a specific spot. That is, rather than attaching the LDs 22a through 22c directly to the housing 39, the arrangement have been adjusted through attaching them to the housing 30 through LD holders 29a through 29c that have adjusting mechanisms.

For example, as illustrated in the cross-sectional diagram of the LD 22a and the LD holder 29a in FIG. 19, the LD 22a is adhesively bonded to the LD holder 29a. This LD holder 29a is held through insertion into an LD wall 30a provided in the housing 30. Moreover, as in the perspective diagram of this part illustrated in FIG. 20, the LD holder 29a has a structure that enables adjustments in four adjustment axes relative to the housing 30: an X-axial translation that is a translation in the X-axial direction (the X direction) comprising the X₁-X₂ axis, a Y-axial translation that is a translation in the Y-axial direction (the Y direction) comprising the Y₁-Y₂ axis, a β₀ rotation that is a rotation around the X axis, and an α₀ rotation that is a rotation around the Y axis. While explanations of the detailed adjusting mechanism are omitted, typically a jog is used to perform the adjustments, where the LD holder 29a is ultimately secured to the housing 30 through adhesive bonding.

Here the X axis (X₁-X₂ axis) is the axis in the direction parallel to the LDs 22a through 22c, and the Y axis (Y₁-Y₂ axis) is the axis in the direction perpendicular to the X axis in the plane of attachment of the LDs to the housing 30.

In order to perform such adjustments, it may be necessary to have proper spacing, relative to the housing 30, for the LD holders 29a to shift and rotate, as illustrated in FIG. 19. Because of this, the actual surface area of contact between the housing 30 and the LD holder 29a is extremely limited. Moreover, while one may anticipate that the heat produced through the laser beam emission by the LD 22a would flow to the LD holder 29a and the housing 30, to be absorbed by the housing 30, and ultimately to be dissipated therefrom, this has not been able to produce an adequate effect because of the coating of the adhesive agent between the two. Moreover, because the adhesive agent is also affected by the heat, resulting in thermal expansion, there is the potential for misalignment of position or direction to occur even when the positioning of the LD 22a has been adjusted with high precision.

### SUMMARY OF THE INVENTION

One or more embodiments of the present invention provide a structure wherein the adjustment of the laser beams emitted from the light-emitting elements can be performed properly, and the heat dissipation performance for the light-emitting elements can be increased.

In one aspect, an image displaying device according to one or more embodiments of the present invention may comprise: a light-emitting element that emits a laser beam and is secured to a housing; and a mirror element adjustably disposed on the housing and that reflects the laser beam emitted from the light-emitting element to be directed to a position that has been determined to be a focusing target, wherein the mirror element is adjustable while being disposed on the housing.

For example, in one or more embodiments, the image displaying device according to the present invention makes it possible to adjust a laser beam emitted from a light-emitting element through the state of arrangement of the mirror elements on the housing. As a result, it is possible to attach the light-emitting elements directly to the housing, because it is not necessary to adjust the arrangement of the light-emitting elements on the housing, and there is no need for an adjustment mechanism for the light-emitting elements. More specifically, because the LD holders are obviated and because there is also no need for space for the adjustment thereof, the LDs can be secured directly to the housing. The result is that the LDs and the housing are secured together with a large surface area and secured strongly, thus enabling the heat from the light-emitting elements be conveyed with maximum efficiency, making it possible to anticipate that the heat will be absorbed, and then dissipated, by the housing. Moreover, if the method of securing is mechanical, through press fitting, rather than bonding, which is an unstable method of securing, then it will be possible to maintain stabilized positional accuracy even when there is a change in temperature.

As another example, one or more embodiments of the present invention may be such that the mirror element is rotatable around a major axis of an ellipse that forms a spot shape of the laser beam on a mirror surface. This makes it possible to achieve the optical axis adjustment that, in the conventional approach, had been performed by shifting the light-emitting element in the minor axis direction of the laser beam. Here the major axis of the laser beam that serves as the axis of rotation of the mirror element refers to the major axis of the laser beam on the mirror surface, corresponding to the major axis of the laser beam emitted from the light-emitting element.

As another example, one or more embodiments of the present invention may be such that the mirror element is rotatable around a minor axis of an ellipse that forms a spot shape of the laser beam on a mirror surface. This makes it possible to achieve the optical axis adjustment that, in the conventional approach, had been performed by shifting the light-emitting element in the minor axis direction of the laser beam. Here the minor axis of the laser beam, which serves as the axis of rotation of the mirror element, refers to the minor axis of the laser beam on the mirror surface, and has the inclination of the emission-axial direction relative to the direction of the minor axis in the laser beam emitted from the light-emitting element.

As another example, one or more embodiments of the present invention may be such that the mirror element is shiftable in a direction that changes a length of an optical path from the light-emitting element. This makes it possible to achieve the brightness adjustment that conventionally has been performed by rotating the light-emitting element around an axis that is the direction of the major axis of the laser beam. Here the direction of movement of the mirror element may be the direction of the minor axis in the laser beam emitted from the light-emitting element, or the emission-axial direction of the laser beam, and, basically, should change the length of the optical path between the light-emitting element and the mirror element.

As another example, one or more embodiments of the present invention may comprise: a plurality of light-emitting elements and a plurality of mirror elements, wherein the plurality of light-emitting elements are arranged lined up in a direction parallel to major axes of ellipses that form the spot shapes of laser beams emitted from each of the plurality of light-emitting elements, and the plurality of mirror elements are disposed lined up corresponding to the plurality of light-emitting elements. This makes it possible to cause the laser beams emitted from the individual mirror elements to be superimposed in the major axis direction, thus making it possible to achieve the brightness adjustment that, conventionally, has been performed through rotating the light-emitting element around an axis in the direction of the short axis of the laser beam. Furthermore, when performing the brightness adjustment, there is no need to rotate or move the mirror elements.

One or more embodiments of the present invention may enable the proper adjustment of the laser beams emitted from the light-emitting elements through the ability to adjust the positions and inclinations of the mirror elements, and makes it possible to increase the ability to dissipate the heat of the light-emitting elements through securing the light-emitting elements directly to the housing.

### BRIEF DESCRIPTION OF THE DRAWINGS

FIG. 1 is a diagram illustrating an example configuration of the critical portions of an image displaying device according to one or more embodiments of the present invention.

FIG. 2 is a diagram according to one or more embodiments of the present invention for explaining the arrangement of the laser diodes.

FIG. 3 is a diagram according to one or more embodiments of the present invention for explaining the relative arrangement between an LD and a dichroic mirror.

FIG. 4 is a diagram according to one or more embodiments of the present invention for explaining the LD adjustment margin that becomes unnecessary.

FIG. 5 is a diagram showing an outside view of a dichroic mirror and a mirror holder.

FIG. 6 is a diagram according to one or more embodiments of the present invention illustrating a dichroic mirror and the state wherein the mirror holder is attached to the housing.

FIG. 7 is a diagram according to one or more embodiments of the present invention illustrating an example of β rotation of a dichroic mirror.

FIG. 8 is an example according to one or more embodiments of the present invention of an a rotation of a dichroic mirror.

FIG. 9 is a diagram according to one or more embodiments of the present invention illustrating an example of the X translation of a dichroic mirror.

FIG. 10 is a perspective diagram according to one or more embodiments of the present invention illustrating an example of optical axis correction when there is a positional misalignment of the LD in the Y direction.

FIG. 11 is a front view diagram according to one or more embodiments of the present invention illustrating an example of optical axis correction when there is a positional misalignment of the LD in the Y direction.

FIG. 12 is a front view diagram according to one or more embodiments of the present invention illustrating an example of optical axis correction when there is a positional misalignment of the LD in the X direction.

FIG. 13 is a front view diagram according to one or more embodiments of the present invention illustrating an example of optical axis correction when there is an inclination error of the LD around the Y axis.

FIG. 14 is an enlargement of FIG. 13.

FIG. 15 is a perspective diagram of the dichroic mirror in FIG. 13.

FIG. 16 is a perspective diagram according to one or more embodiments of the present invention showing an example of optical axis correction for the case wherein the LD has inclination error around the X axis.

FIG. 17 is a diagram according to one or more embodiments of the present invention illustrating the shape of the spot of the laser beam at the point of incidents on the prism in FIG. 16.

FIG. 18 is a diagram according to one or more embodiments of the present invention illustrating an example configuration of the critical portions of an image displaying device according a conventional approach.

FIG. 19 is a diagram according to one or more embodiments of the present invention illustrating one example of a method for securing an LD in a conventional approach.

FIG. 20 is a diagram according to one or more embodiments of the present invention illustrating the LD adjusting axes in the conventional approach.

FIG. 21 is a diagram according to one or more embodiments of the present invention illustrating the state wherein the mirror surface of a dichroic mirror is viewed from the front.

FIG. 22 is a diagram according to one or more embodiments of the present invention illustrating the state wherein a dichroic mirror is viewed from a side face in the X direction.

FIG. 23 is a front view diagram according to one or more embodiments of the present invention illustrating another example of optical axis correction in the case wherein an LD has positional misalignment in the X direction.

FIG. 24 is a perspective diagram according to one or more embodiments of the present invention illustrating another example of optical axis correction in a case wherein an LD has inclination error around the X axis.

FIG. 25 is a diagram according to one or more embodiments of the present invention illustrating an example of the rotational axes of a dichroic mirror.

FIG. 26 is an auxiliary view in the direction of the arrow J in FIG. 27.

FIG. 27 is a diagram wherein FIG. 25 is viewed from the direction of the arrow G.

### DETAILED DESCRIPTION OF THE INVENTION

Embodiments of the present invention can be applied to a variety of image displaying devices for displaying color images by combining laser beams of different color components that are outputted from a plurality of laser beam source portions, but in the below the explanation will use an example of a laser projector as a specific example. This laser projector projects and displays a color image onto a projection plane by combining laser beams of the three color components, a red component (R), a green component (G), and a blue component (B), and scans the combined beam using a scanning mirror.

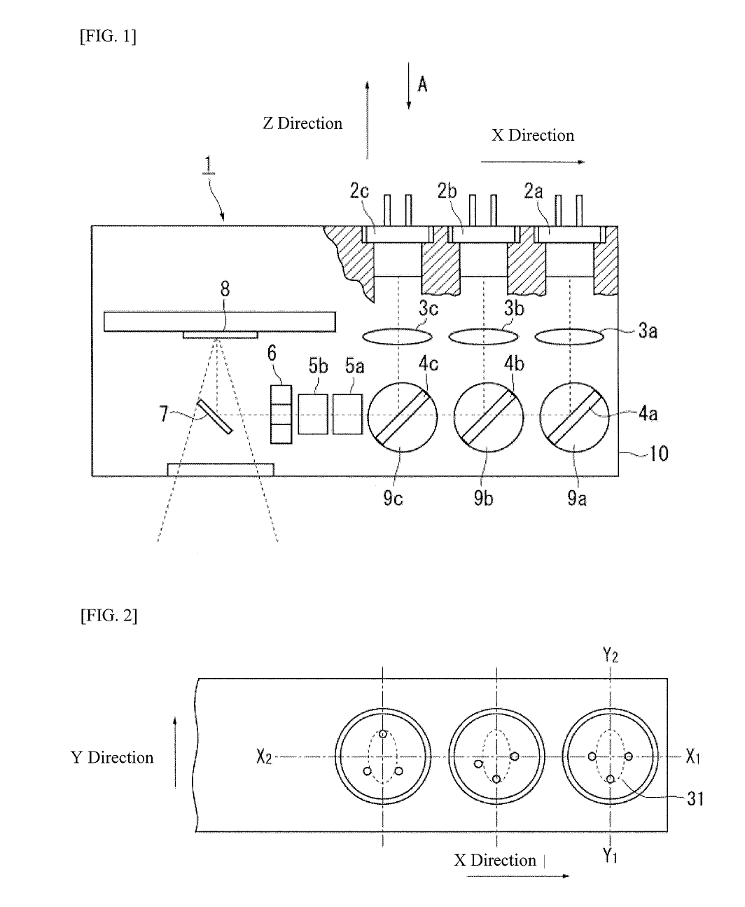

FIG. 1 illustrates an example configuration of the laser projector 1 according to one or more embodiments.

In one or more embodiments, three laser diodes (LDs) 2 (2a through 2c) for emitting laser beams of different color components may be arranged in parallel. The laser beams emitted from LDs 2a through 2c may pass through lenses 3a through 3c, corresponding to the respective color components, to be formed into parallel beams, and may be emitted toward dichroic mirrors 4a through 4c. The dichroic mirrors 4a through 4c may each have the property of reflecting the laser beam of the corresponding color component and passing the others, and may be disposed so that the laser beams incident on the individual lenses will be emitted toward the same optical axis (will be combined). The beam combined through the dichroic mirrors 4a through 4c may be directed toward a scanning mirror 8, passing sequentially through two prisms 5a and 5b, an aperture 6, and a reflecting mirror 7 to be emitted from the scanning mirror 8 toward an external projection plane while undergoing scanning dislocation. These components 2 through 8 may be secured by or disposed on a housing 10 in a specific arrangement.

The LDs 2a through 2c may be light-emitting elements (laser beam sources) that output laser beams of mutually differing color components, and may be driven, independently of each other, by driving currents supplied individually from a laser driver (not shown) based on a video signal so that each outputs a laser beam of a single color component. Doing so causes laser beams of single color components of specific wavelengths to be outputted, such as a green component (G) from the LD 2a, a blue component (B) from the LD 2b, and a red component (R) from the LD 2c.

The dichroic mirrors 4a through 4c may be minor elements having the property of reflecting a laser beam of only a specific wavelength and passing the others, and may combine the laser beams of the individual color components emitted from the LDs 2a through 2c. For example, the dichroic mirror 4a may reflect a G laser beam, emitted by the LD 2a, to emit it to the downstream side. The dichroic minor 4b may reflect the B laser beam, emitted by the LD 2b, and pass the G laser beam emitted from the dichroic mirror 4a on the upstream side, to emit the individual laser beams to the downstream side. The dichroic minor 4c may reflect the R laser beam, emitted by the LD 2c, and pass the G and B laser beams emitted from the upstream dichroic minor 4b, to emit the individual laser beams to the downstream side. As a result, the final color combined beam may be emitted from the dichroic mirror 4c.

Prisms 5a and 5b may adjust the orientation of the optical axis, for example, of the combined beam that has been emitted from the upstream dichroic mirror 4c, to emit it towards an aperture 6.

The aperture 6 may be a component having an opening portion of a specific area in the light path of the laser beam, and passing the laser beams through the opening portion limits the optical flux of the laser beam.

The mirror 7 may reflect the laser beam, which has passed through the aperture 6, to emit it toward the downstream scanning minor 8.

The scanning mirror 8 may be dislocated, scanning in the horizontal direction (the X direction) and the vertical direction (the Y direction), through a scanning minor driver (not shown) based on a video signal, and the color combined beam incident thereon may be reflected in accordance with the deflection angle thereof to be projected onto the projection plane. An MEMS (Micro Electro Mechanical System) scanning mirror, which is useful in miniaturization, reduced power consumption, increased processing speed, and the like, may be used as the scanning mirror 8.

The mechanisms for attaching the LDs 2 (2a through 2c), the lenses 3 (3a through 3c), and the dichroic minors 4a through 4c to the housing 10 will be explained next.

In one or more embodiments, the LDs 2 for the individual color components may be lined up in the X-axial direction (the X direction), which is the X₁-X₂ axis, and may be secured through being attached directly to the housing 10. For example, the LDs 2 may be secured through a mechanical securing method of press fitting into the housing 10

The shape of a spot of a laser beam emitted from an LD 2 may form an elliptical shape, not a circular shape. FIG. 2 is a diagram where FIG. 1 is viewed from the direction of the arrow A, where, as indicated by the dotted line in this figure, each LD 2 is arranged so that the major axis of the ellipse of the spot shape 31 will be parallel to the direction of the Y axis (the Y direction), which is the Y₁-Y₂ axis. The laser beam with a spot shape in FIG. 2 may be much smaller than illustrated.

In one or more embodiments, the X axis (the X₁-X₂ axis) may be the axis in the direction in which the LDs 2 are lined up, and the Y axis (the Y₁-Y₂ axis) may be the axis in the direction perpendicular to the X direction, in the plane wherein the LDs are attached to the housing 10.

In one or more embodiments, the dichroic mirrors 4 of the individual color components may each be attached to the housing 10 through the mirror holders 9 (9a through 9c) having the adjusting mechanism described below. At this time, the dichroic mirrors 4 may be arranged in a parallel line in relation to the arrangement of the LDs 2.

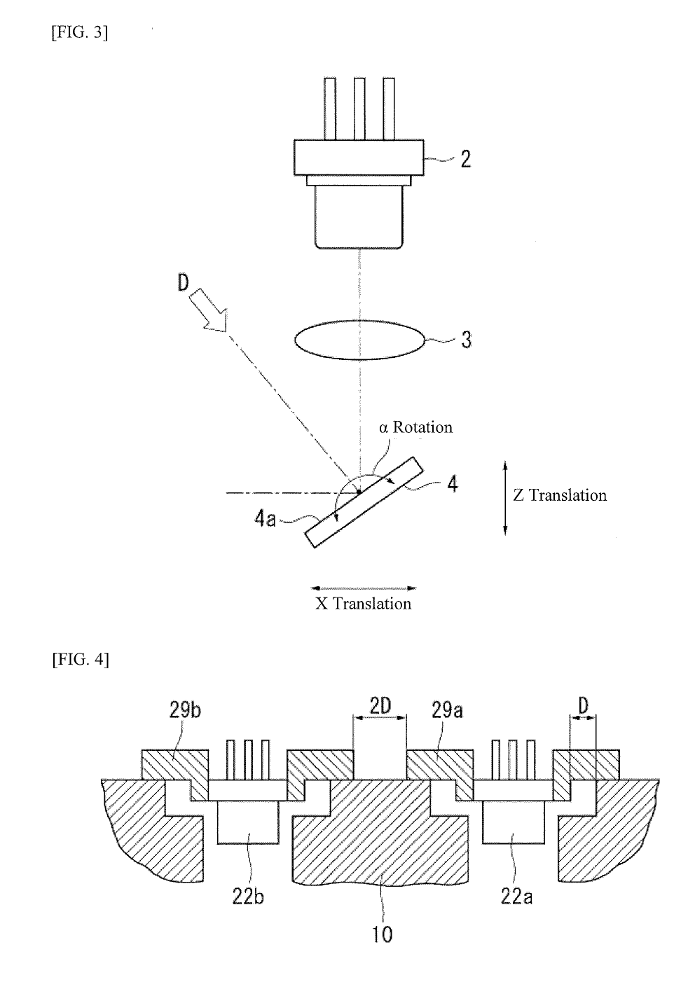

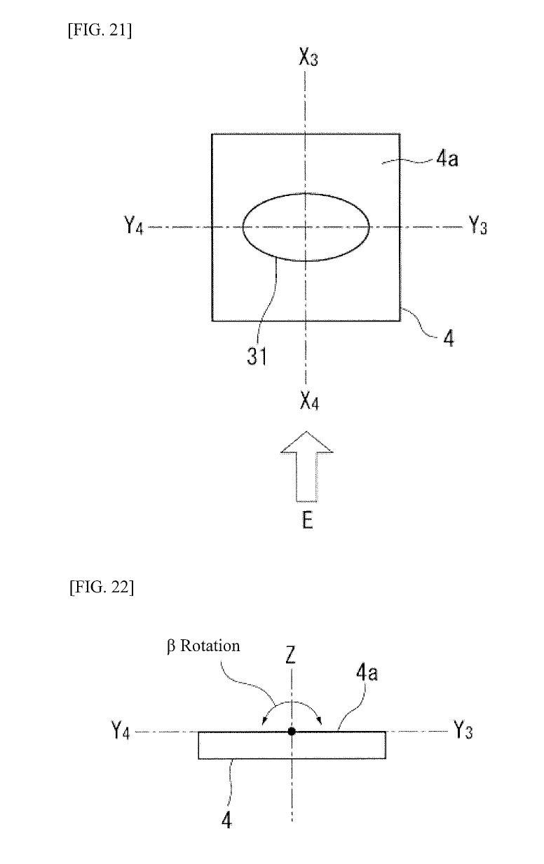

FIG. 3 shows an example of the relationship of the arrangements of the LD 2 and the dichroic mirrors 4. FIG. 3 is a diagram viewed from the same direction as in FIG. 1. Moreover, FIG. 21 is a diagram viewed from the direction of the arrow D in FIG. 3, and shows an example of the state wherein the mirror surface 4a of a dichroic mirror 4 is viewed from the front. Moreover, FIG. 22 shows an example of the state when viewed from the direction of the arrow E in FIG. 21, that is, when the dichroic mirrors 4 are viewed from the side face in the X direction. The explanation below will use these three figures, FIG. 3, FIG. 21, and FIG. 22.

In one or more embodiments, the dichroic mirror 4 may be structured so as to enable X translation, which is shifting in the direction parallel to the X direction in FIG. 1 (the direction of the X₁-X₂ axis in FIG. 2). Moreover, the dichroic mirror 4 may be structured so as to enable a rotation, which is rotation around the Y₃-Y₄ axis on the mirror surface 4a. Moreover, the dichroic mirror 4 may be structured so as to enable β rotation, which is rotation around the X₃-X₄ axis on the mirror surface 4a.

In one or more embodiments, the Y₃-Y₄ axis may be an axis parallel to the Y direction (the direction of the Y₁-Y₂ axis) in FIG. 2, and the X₃-X₄ axis may be an axis in a direction perpendicular to the Y₃-Y₄ axis on the mirror surface 4a.

As described above, the dichroic mirror 4 may have three adjusting axes: X translation, a rotation, and β rotation. Incidentally, as illustrated in FIG. 21, the spot shape 31 of the laser beam emitted from an LD 2, on the mirror surface 4a of the dichroic mirror 4, may have the Y₃-Y₄ axis as the major axis direction of the ellipse. This makes it possible to align the major axis of the spot shape 31 within the Y direction in FIG. 2 for each individual laser beam reflected by the dichroic mirrors 4.

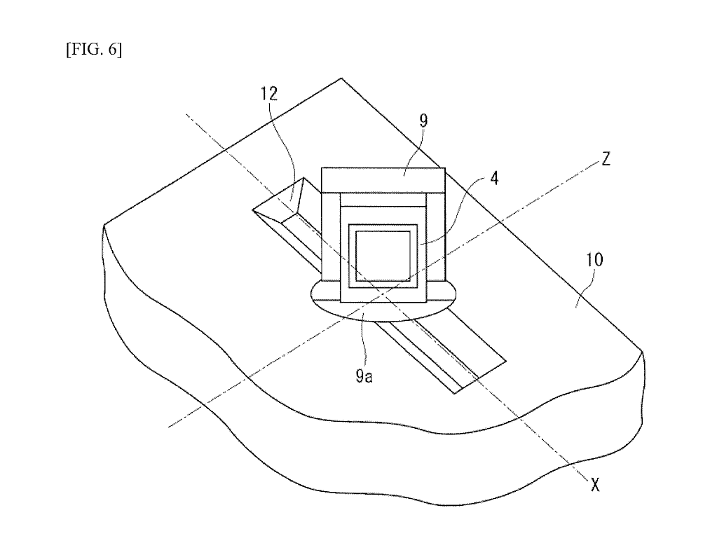

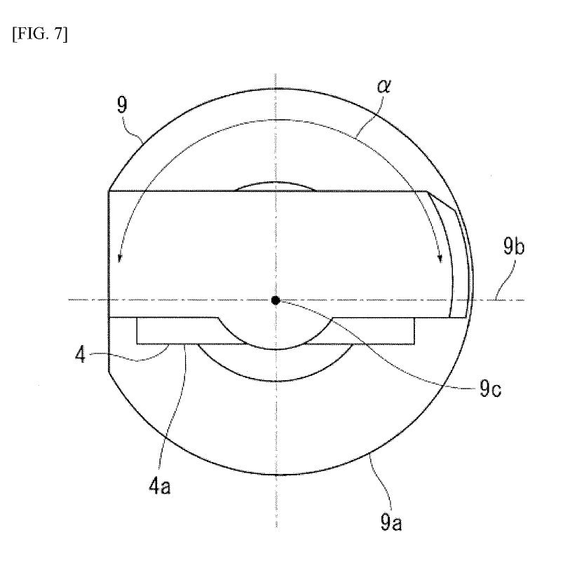

FIG. 5 shows an example of an exterior view of a dichroic mirror 4 and a mirror holder 9. Moreover, FIG. 6 shows an example of the dichroic mirror 4 and the state wherein the mirror holder 9 is attached to the housing 10.

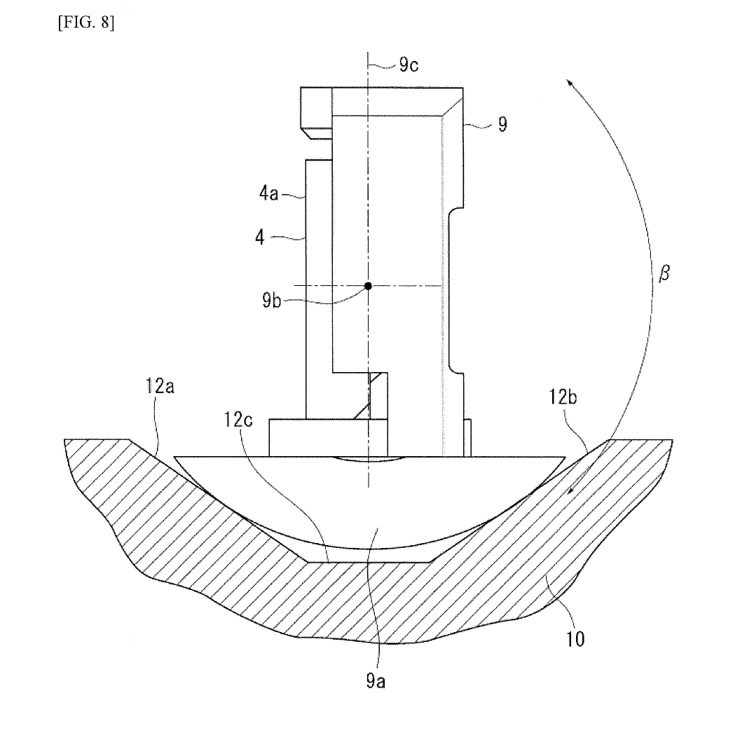

In one or more embodiments, the bottom portion of the mirror holder 9 may be formed protruding in a spherical surface shape 9a, and an X-axial direction groove portion 12, having a recessed shape corresponding to the spherical surface shape 9a, may be formed in the housing 10. The groove portion 12 of the housing 10, as illustrated in FIG. 8, may be made from three flat planes: a bottom portion 12c, an inclined plane portion (A) 12a, and an inclined plane portion (B) 12b. Consequently, it is possible to rotate in any direction, in 360° , following this spherical surface shape 9a, centered on the center point of the spirit.

In one or more embodiments, as illustrated in FIG. 7, with the mirror holder 9, in which the dichroic mirror 4 is installed, in a state disposed in the groove portion 12 of the housing 10, the dichroic mirror 4 may be α rotated by rotating the mirror holder 9 around the axis 9c that passes in the lengthwise direction through the mirror surface 4a of the dichroic mirror 4.

In one or more embodiments, as illustrated in FIG. 8, the dichroic mirror 4 may be β rotated by rotating the mirror holder 9 around the axis 9b that passes in the crosswise direction through the mirror surface 4a of the dichroic mirror 4.

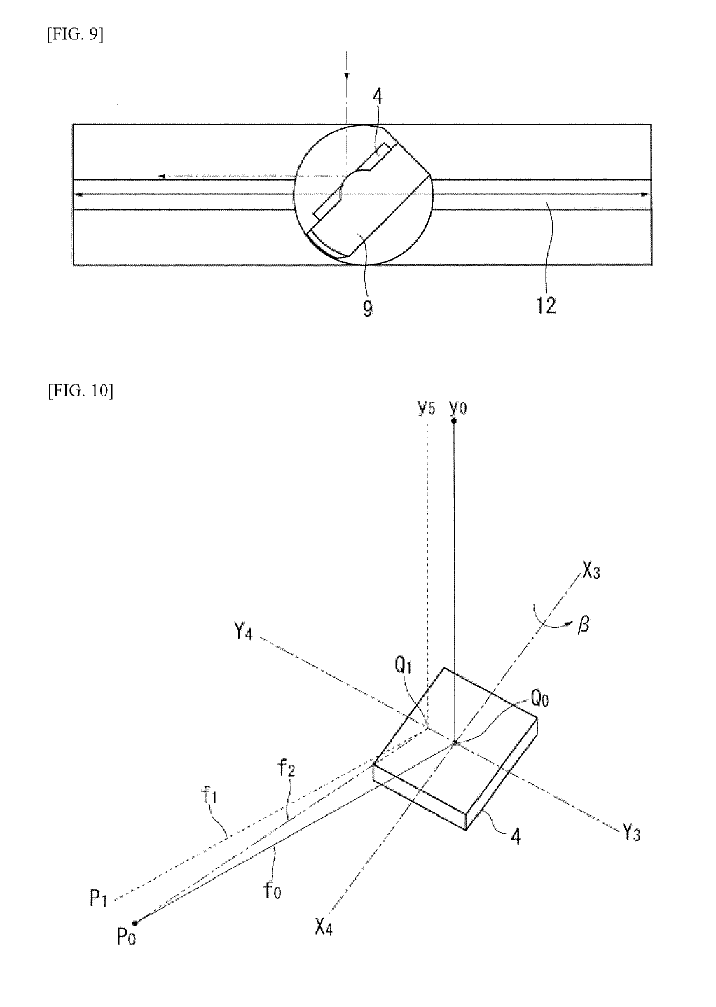

In one or more embodiments, as illustrated in FIG. 9, the dichroic mirror 4 may be X translated by moving the mirror holder 9 along the groove portion 12.

The relationship between the axes 9b and 9c, illustrated in FIG. 7 and FIG. 8, and the X₃-X₄ axis and Y₃-Y₄ axis, illustrated in FIG. 21, will be explained below.

After the inclination and position of the mirror holder 9 have been adjusted, it may be secured, through an adhesive, or the like, to the housing 10.

The structure of the mirror holder 9, the shape of the groove portion 12 in the housing 10, and the like, illustrated in FIG. 5 through FIG. 9, are no more than one example, where the a rotation, β rotation, and X translation of the dichroic mirrors 4 can be achieved using mirror holders 9 and housings 10 of a variety of other different forms.

Certain embodiments will be used below to explain a method for adjusting the optical axes of the laser beams in the laser projector 1 structured as described above.

### Embodiment 1

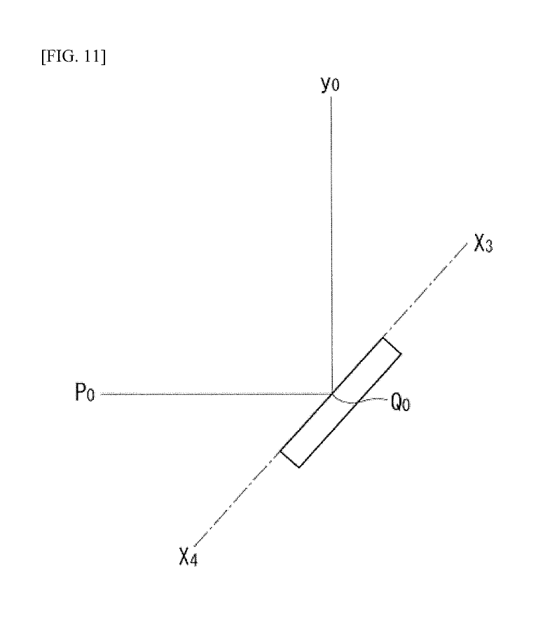

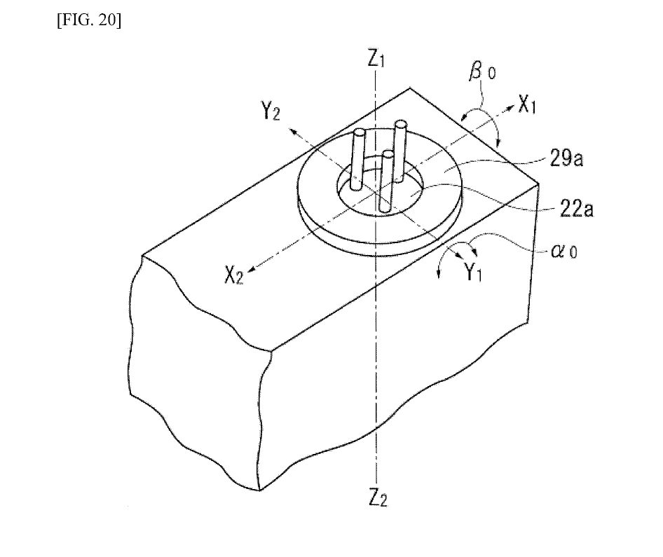

An example of a correcting method for a case wherein the center point of the LD in FIG. 20 is positionally misaligned in the direction of the Y₁-Y₂ axis will be explained using FIG. 10 and FIG. 11. FIG. 10 is a perspective diagram of an example of a dichroic mirror 4, and FIG. 11 is FIG. 10 viewed from the Y₃ direction (the same direction as in FIG. 1). In the present example, the center point of the LD 5 may be at the y₅ position which is offsetted by Δy from the y₀ position that is the design position in the direction of the Y₁-Y₂ axis.

In FIG. 10, the optical axis of the laser beam, when the LD is attached at the y₀ position, is indicated by the solid line, and the optical axis of the laser beam when the LD is be attached at the y₅ position is indicated by the dotted line.

That is, the optical axis of the laser beam emitted from the LD at the y₀ position may be reflected from the Q₀ position on the mirror surface 4a of the dichroic mirror 4, and may advance along the optical axis f₀, to arrive at the P₀ position in the center of the laser beam incident surface in the prism 5a.

In contrast, the optical axis of the laser beam emitted from the LD at the y₅ position may be reflected from the Q₁ position on the mirror surface 4a of the dichroic mirror 4, and may advance along the optical axis f₁, to arrive at a P₁ position shifted from the center of the laser beam incident surface in the prism 5a.

To direct the laser beam emitted from the LD at the y₅ position to the final P₀ position, the optical axis f₁ may be inclined to f₂. Here the optical axis f₂ may be an axis that arrives at the P₀ position on the prism 5a from the reflection position (the Q₁ position) on the mirror surface 4a. This optical axis correction can be achieved through β rotation of the dichroic mirror 4 in the counterclockwise direction, when viewed from the X₃ direction.

That is, if the LD is positionally misaligned in the Y direction, it can be corrected through a β rotation of the dichroic mirror 4.

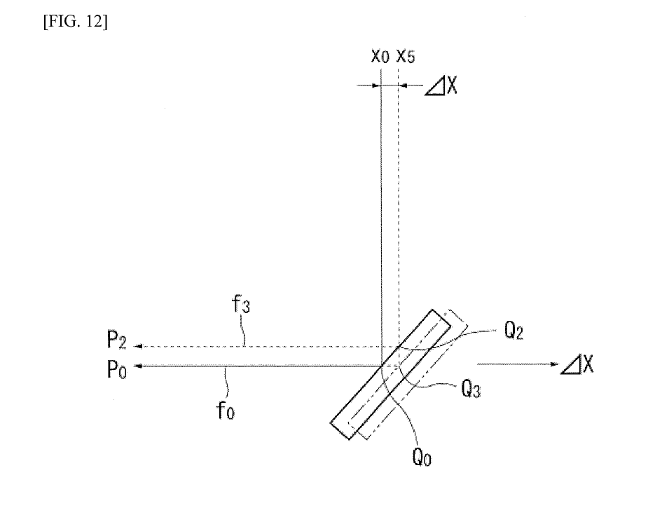

An example of a correcting method for the case wherein the center point of the LD in FIG. 20 is positionally misaligned in the direction of the X₁-X₂ axis will be explained next using FIG. 12. FIG. 12 is a perspective diagram of an example of a dichroic mirror 4, viewed from the same direction as in FIG. 1. In the present example, the center point of the LD 5 may be at the x₅ position which is offsetted by Δx from the x₀ position that is the design position in the direction of the X₁-X₂ axis.

In FIG. 12, the optical axis of the laser beam, when the LD is attached at the x₀ position, is indicated by the solid line, and the optical axis of the laser beam when the LD is attached at the x₅ position is indicated by the dotted line.

That is, the optical axis of the laser beam emitted from the LD at the x₀ position may be reflected from the Q₀ position on the mirror surface 4a of the dichroic mirror 4, and may advance along the optical axis f₀, to arrive at the P₀ position in the center of the laser beam incident surface in the prism 5a.

In contrast, the optical axis of the laser beam emitted from the LD at the x₅ position may be reflected from the Q2 position on the mirror surface 4a of the dichroic mirror 4, and may advance along the optical axis f₃, to arrive at a P₂ position shifted from the center of the laser beam incident surface in the prism 5a.

To direct the laser beam emitted from the LD at the x₅ position to the final P₀ position, the optical axis f₀ may be shifted to f₃. This optical axis correction can be achieved through performing a parallel translation of the dichroic mirror 4 by an amount of Δx in the X direction (shifting to the position of the double dotted line). As a result, the reflection position on the mirror surface 4a will be the Q₃ position wherein the Q₀ position has undergone a parallel translation by Δx in the X direction, so that the laser beam reflected from that position will, thereafter, advance along the optical axis f₀ to arrive at the P₀ position.

That is, if the LD is positionally misaligned in the X direction, it can be corrected through a X translation of the dichroic mirror 4.

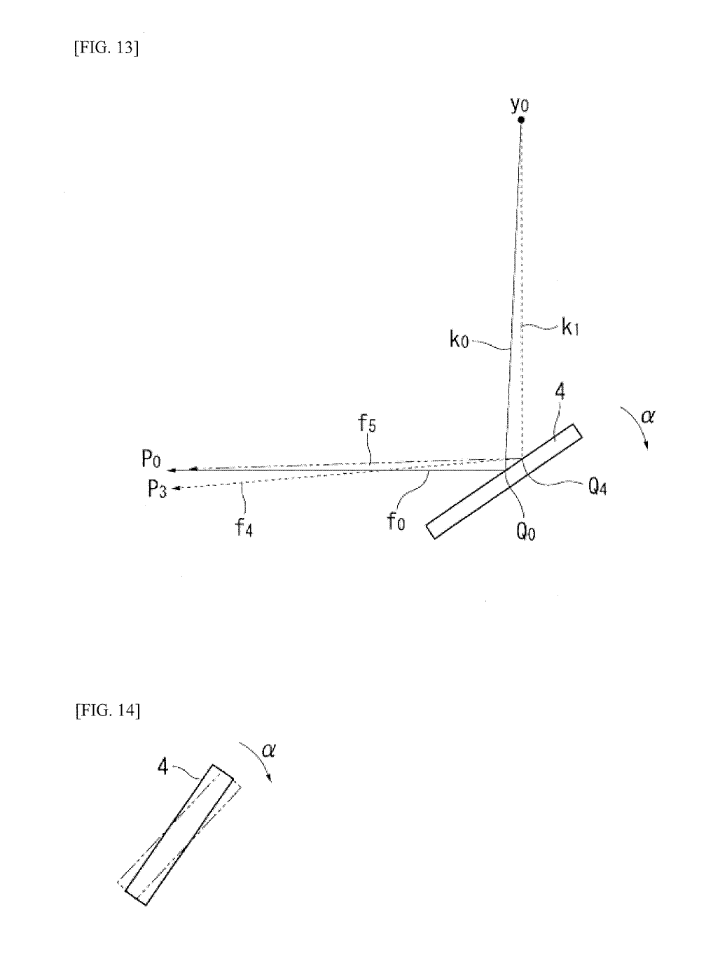

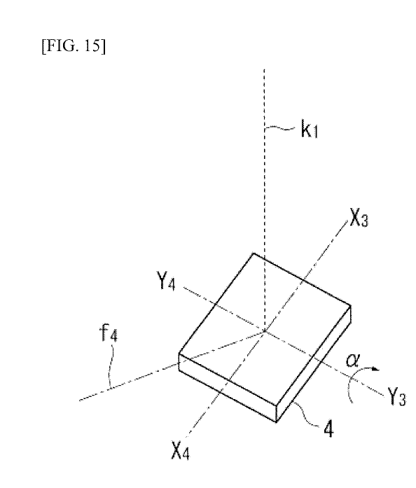

An example of a method for correcting for a case wherein the center point of the LD in FIG. 20 is at the design position x₀, y₀ and the optical axis of the laser beam is inclined, relative to the Z axis, around the Y axis will be explained using FIG. 13, FIG. 14, and FIG. 15. FIG. 13 is a diagram wherein the dichroic mirror 4 is viewed from the same direction as in FIG. 1, FIG. 14 is an enlargement of the dichroic mirror 4 part, and FIG. 15 is a perspective diagram of the dichroic mirror 4. In the present example, the LD is assumed to be inclined rotated in the clockwise direction by α₁ when viewed from the Y₁ direction in FIG. 20.

In FIG. 13, the optical axis of the laser beam when the LD is attached without being inclined is shown by the dotted line, and the optical axis of the laser beam when the LD is attached with an inclination of α₁, relative to the Z axis, is shown by the dotted line.

That is, the optical axis k₀ of the laser beam emitted from an LD attached at the design position without being inclined may be parallel to the Z axis, and may advance along the optical axis f₀, to arrive at the P₀ position in the center of the laser beam incident surface in the prism 5a.

In contrast, the laser beam emitted from the LD attached with an inclination of α₁ relative to the Z axis may advance along the optical axis k₁, which has an inclination of α₁, to be reflected at the position Q₄ on the mirror surface 4a of the dichroic mirror 4, and may advance along the optical axis f₄, to arrive at a P₃ position shifted from the center of the laser beam incident surface in the prism 5a.

To direct the laser beam emitted from an LD attached with an inclination of α₁ relative to the Z axis to the final P₀ position, the optical axis f₄ may be inclined to f₅. Here the optical axis f₅ may be an axis that arrives at the P₀ position on the prism 5a from the reflection position (the Q3 position) on the mirror surface 4a. This optical axis correction can be achieved through a rotation of the dichroic mirror 4 in the clockwise direction, when viewed from the Y₃ direction (referencing FIG. 15). That is, the dichroic mirror 4 may be inclined to the position of the dotted line, from the position of the solid line, illustrated in FIG. 14. As described above, for an LD that has inclination error around the Y axis, it can be corrected through an a rotation of the dichroic mirror 4.

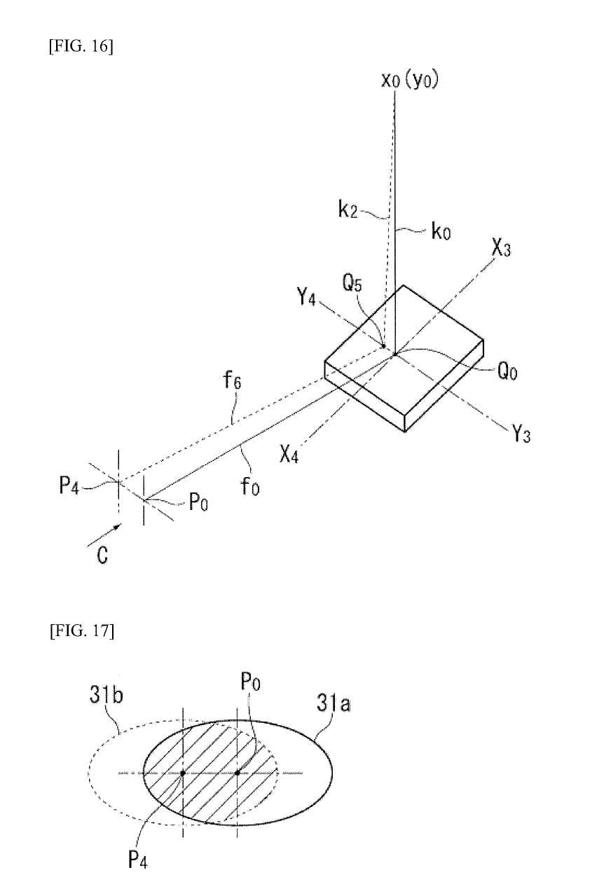

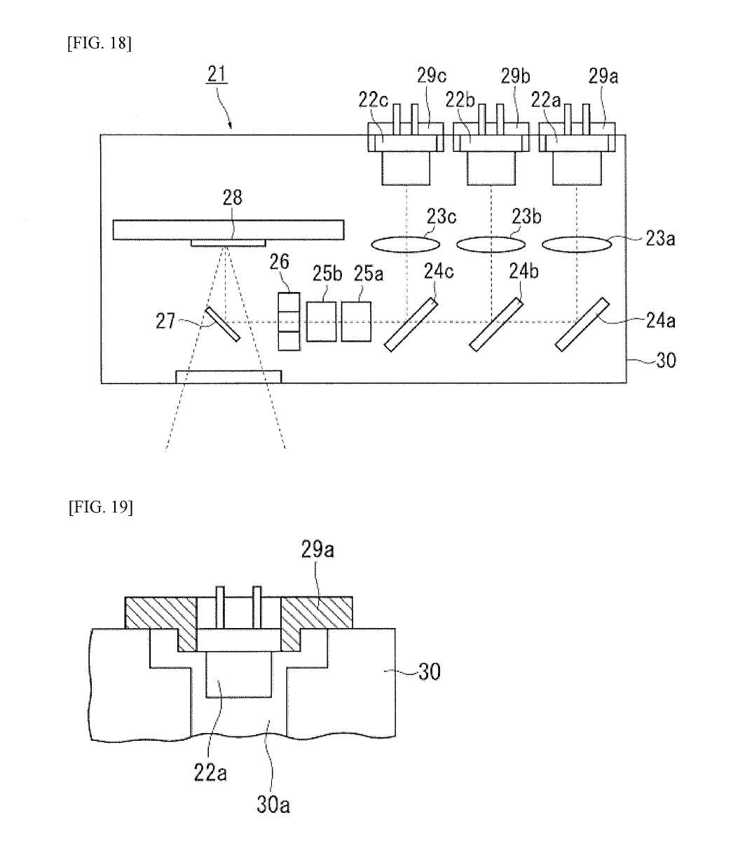

An example of a method for correcting for a case wherein the center point of the LD in FIG. 20 is at the design position x₀, y₀ and the optical axis of the laser beam is inclined, relative to the Z axis, around the X axis will be explained using FIG. 16, and FIG. 17. FIG. 16 is a perspective diagram of a dichroic mirror 4, and FIG. 17 is a diagram showing the incident surface of the laser beam in the prism 5a, viewed from the direction of the arrow C in FIG. 16. In the present example, the LD is assumed to be inclined rotated in the clockwise direction by β₁ when viewed from the X₁ direction in FIG. 20.

In FIG. 16, the optical axis of the laser beam when the LD is attached without being inclined is shown by the dotted line, and the optical axis of the laser beam when the LD is attached with an inclination of β₁, relative to the Z axis, is shown by the dotted line.

That is, the optical axis k₀ of the laser beam emitted from an LD attached at the design position without being inclined may be parallel to the Z axis, and may advance along the optical axis f₀, to arrive at the P₀ position in the center of the laser beam incident surface in the prism 5a.

In contrast, the laser beam emitted from the LD attached with an inclination of β₁ relative to the Z axis may advance along the optical axis k₂, which has an inclination of β₁, to be reflected at the position Q5 on the mirror surface 4a of the dichroic mirror 4, and may advance along the optical axis f₆, to arrive at a P₄ position shifted from the center of the laser beam incident surface in the prism 5a.

In the example of FIG. 17, the ellipse with the solid line is the spot shape 31 a of the laser beam at the P₀ position, which is the design center, and the ellipse with the dotted line is the spot shape 31b of the laser beam at the P₄ position. Moreover, the overlap between 31a and 31b is shown by the hatching. As illustrated, most of this is the hatching area, although this will depend on the amount of misalignment, so it can be determined that this is adequate for the amount of light.

In this example, the fact that the spot shape of the laser beam is an ellipse can be used to absorb the inclination error of the LD around the X axis by aligning the major axis of the ellipse with the Y-axial direction, which is the direction of the misalignment. As a result, no correction is performed as with the other misalignments.

As explained in reference to FIG. 12, the positional misalignment of the LD in the X direction was corrected through a X translation wherein the dichroic mirror 4 was shifted from the position of the dotted line to the position of the double dotted line, but here it can be understood easily, by viewing the diagram, that for this positional misalignment, the correction may be achieved instead through a Z translation wherein the dichroic mirror 4 is shifted in the Z direction. Consequently, the method of correction that was explained for the X direction in the present embodiment may be replaced with a Z translation. Thus, the groove portion 12 in FIG. 6, FIG. 8, and FIG. 9, may be structured in the Z direction, rather than the X direction.

In this example, the laser projector 1 is configured such that it is possible to adjust the position of the dichroic mirror 4 in a state wherein the dichroic mirror 4 is disposed on the housing 10 (adjustably disposed), structured through attaching a mirror holder 9 to the dichroic mirror 4 and holding it on the housing 10 through the provision of a plurality of LDs 2 (2a through 2c) for emitting laser beams of an elliptical spot shape, a plurality of dichroic mirrors 4a through 4c for directing to specific positions (the positions that are the focusing targets relative to the aperture 6, the scanning mirror 8, and the like) by reflecting the laser beams emitted from the LDs 2, a plurality of mirror holders 9 (9a through 9c) that have a rotation, f3 rotation, and X translation (or Z translation) adjusting mechanisms, and a housing 10 to which the laser diodes 2 and the mirror holders 9 are attached.

Consequently, the laser projector 1 of the present example makes it possible to change or adjust the position of the dichroic mirrors 4 attached to the mirror holders 5 through performing a rotations, 13 rotations, and X translations (or Z translations) of the mirror holders 9 on the housing 10. This performs the optical axis adjustments and brightness adjustments for the laser beam so as to properly focus the laser beams emitted from the LDs 2 onto a specific position.

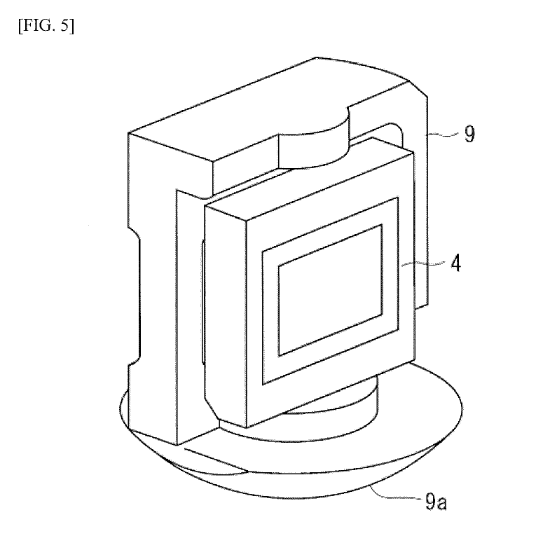

That is, the laser projector 1 of the present example has no need for adjusting the arrangement of the LDs 2, eliminating the need for adjusting mechanisms such as the LD holders, thus making it possible to attach the LDs 2 directly to the housing 10. Because of this, the heat from the LDs 2 can flow efficiently to the housing 10, making it possible to increase the heat dissipating performance. Moreover, as illustrated in the example of FIG. 4, the adjustment margin for the LDs 2 (the space for adjustments) D, which was required in the conventional approach, becomes unnecessary, making it possible to increase further the heat dissipating performance through the use of a structure wherein a heat dissipating structure, such as a fin, or the like, is provided in this space D.

Moreover, even in a case wherein an adhesive agent is used in securing the dichroic mirrors 4 to the mirror holders 9, the adhesive agent can be kept away from the LDs 2, which are heat sources, making it possible to prevent the thermal expansion of the adhesive agent through the heat produced by the LDs 2, thus making it possible to prevent misalignment of the laser beams.

Moreover, because, in the laser projector 1 in the present example, it is possible to achieve, through specifying the direction of the LD 2 when attaching to the housing 10, the brightness adjustment that, in the conventional approach, was performed through a β rotation of the LD around an axis in the direction of the minor axis of the laser beam, thus making it possible to eliminate the adjustments corresponding thereto. That is, in contrast to the conventional approach wherein four types of adjustments were performed on the LDs, namely X translation, Y translation, a rotation, and β rotation, the adjustment operation is simplified by only needing three types of adjustments for the dichroic mirrors: a rotation, 13 rotation, and X translation (or Z translation).

Here it is possible to further increase the heat dissipating performance through innovations with the arrangement of pins for the LDs 2. That is, of the three pins that are provided for an LD 2, the pin 11 (11a through 11c) at the highest temperature, connected to the light-emitting portion of the LD 2, may be disposed differently from those of the adjacent LDs 2.

While in the example in FIG. 2 the pin 11b for the LD 2b and the pin 1 lc for the LD 2c are mutually different, the pin 11a of the LD 2 is not mutually different from the pin 11b of the LD 2b. This is because even separating the pin 11c of the LD 2c of the color component that produces the greatest amount of heat (in this case, R) from the pin 11b of the LD 2b of another color component adjacent thereto (in this case, B) can produce an effect of increasing the heat dissipating performance. Of course, the arrangement instead may be one wherein the pins 11 will be mutually differing between all mutually adjacent LDs 2.

Moreover, while in the present example the lenses 3 for each of the color components were each attached directly to the housing 10, instead the lenses 3 may be attached through lens holders having adjusting mechanisms for Z translation (shifting in the Z-axial direction), to produce a structure wherein Z translation adjustments are possible in a state wherein the lenses 3 are supported by the housing 10. In this case it is possible to adjust the distance between the LD 2 and the lens 3 through Z translation of the lens 3.

### Embodiment 2

In Embodiment 1 the explanation was for a method wherein the inclination and positional misalignment of the LDs were corrected through the use of a rotation, β rotation, and X translation (or Z translation) of the dichroic mirrors 4 and the major axes and minor axes of the spot shapes of the laser beams, but, as described below, the inclination errors and positional misalignments of the LDs can also be corrected through a rotation and 13 rotation of the dichroic mirrors 4 alone.

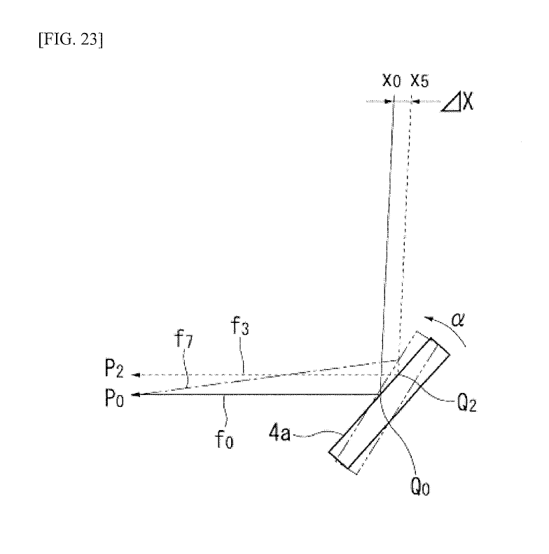

While in Embodiment 1 the positional misalignment of the LDs in the X direction was corrected through X translation of the dichroic mirrors 4, the ability to correct this through a rotation of the dichroic mirrors 4 will be explained below, using FIG. 23. FIG. 23 is a diagram viewing a dichroic mirror 4 from the same direction as in FIG. 1.

In FIG. 23, the optical axis of the laser beam, when the LD is attached at the x₀ position, which is the design position in the X direction, is indicated by the solid line, and the optical axis of the laser beam when the LD is attached at the x₅ position, which is shifted by Δx from the x₀ position, is indicated by the dotted line.

That is, the optical axis of the laser beam emitted from the LD at the x₀ position may be reflected from the Q₀ position on the mirror surface 4a of the dichroic mirror 4, and may advance along the optical axis f₀, to arrive at the P₀ position in the center of the laser beam incident surface in the prism 5a.

In contrast, the optical axis of the laser beam emitted from the LD at the x₅ position may be reflected from the Q2 position on the mirror surface 4a of the dichroic mirror 4, and may advance along the optical axis f₃, to arrive at a P₂ position shifted from the center of the laser beam incident surface in the prism 5a.

To direct the laser beam emitted from the LD at the x₅ position to the final P₀ position, the optical axis f₃ may be inclined to f₇. Here the optical axis f₇ is an axis that arrives at the P₀ position on the prism 5a from the reflection position on the mirror surface 4a. This optical axis correction can be achieved through a rotation of the dichroic mirror 4 in the counterclockwise direction, when viewed from the Y₃ direction (referencing FIG. 15). That is, the dichroic mirror 4 may be inclined to the position of the solid line, from the position of the dotted line, illustrated in FIG. 14.

As described above, it is understood that if the LD is positionally misaligned in the X direction, it can be corrected through a rotation of the dichroic mirror 4.

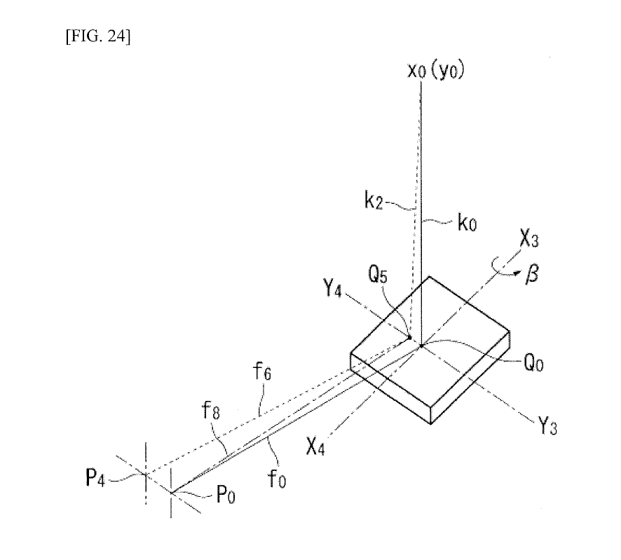

While in the first embodiment the explanation was for the use of the fact that the spot shape of the laser beam is an ellipse, to absorb inclination error of the LD around the X axis by causing the major axis of the ellipse to match the Y-axial direction, which is the direction of the misalignment, the ability to correct using a 13 rotation of the dichroic mirror 4 will be explained below using FIG. 24. FIG. 24 is a perspective diagram of the dichroic mirror 4. In this example, it is assumed that the LD is inclined rotated in the counterclockwise direction by β₁, when viewed from the X₁ direction in FIG. 20.

In FIG. 24, the optical axis of the laser beam when the LD is attached without being inclined is shown by the dotted line, and the optical axis of the laser beam when the LD is attached with an inclination of β₁, relative to the Z axis, is shown by the dotted line.

That is, the optical axis k₀ of the laser beam emitted from an LD attached at the design position without being inclined may be parallel to the Z axis, and may advance along the optical axis f₀, to arrive at the P₀ position in the center of the laser beam incident surface in the prism 5a.

In contrast, the laser beam emitted from the LD attached with an inclination of β₁ relative to the Z axis may advance along the optical axis k₂, which has an inclination of β₁, to be reflected at the position Q₅ on the mirror surface 4a of the dichroic mirror 4, and may advance along the optical axis f₆, to arrive at a P₄ position shifted from the center of the laser beam incident surface in the prism 5a.

To direct the laser beam emitted from an LD attached with an inclination of β₁ relative to the Z axis to the final P₀ position, the optical axis f₆ may be inclined to f₈. Here the optical axis f₈ is an axis that arrives at the P₀ position on the prism 5a from the reflection position (the Q5 position) on the mirror surface 4a. This optical axis correction can be achieved through 13 rotation of the dichroic mirror 4 in the counterclockwise direction, when viewed from the X₃ direction.

As described above, for an LD that has inclination error around the X axis, it can be corrected through β rotation of the dichroic mirror 4.

Because the result is that the optical axis of the laser beam is ultimately focused on the P₀ position, it can be understood that the correction can be made without the orientation of the spot shape, explained in the first embodiment, being controlled. Moreover, it is also understood that the positional misalignments and inclination errors of the LDs can all be corrected through a rotations and β rotations of the dichroic mirrors 4.

In the explanations thus far the rotational axes of the dichroic mirrors 4 have used the Y₃-Y₄ axis and the X₃-X₄ axis that exist on the mirror surface 4a of the dichroic mirror 4, as represented in FIG. 24. On the other hand, the axes 9b and 9c that were explained as the axes of rotation of the dichroic mirror 4 in FIG. 7 and FIG. 8 may not exist on the mirror surface 4a of the dichroic mirror 4. This discrepancy will be explained here.

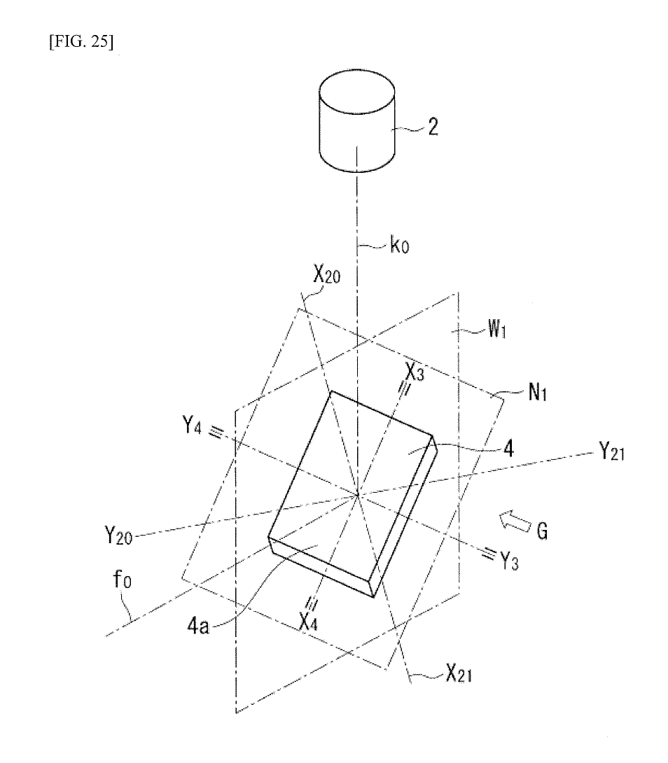

FIG. 25 illustrates examples of axes of rotation of the dichroic mirror 4.

In this figure, the spatial plane wherein the optical axes k₀ and f₀ of the LDs 2 exist is shown as W₁, and the spatial plane wherein the mirror surface 4a exists is indicated as N₁. As a result, the two spatial planes Wᵢ and N₁ intersect on the X₃-X₄ axis.

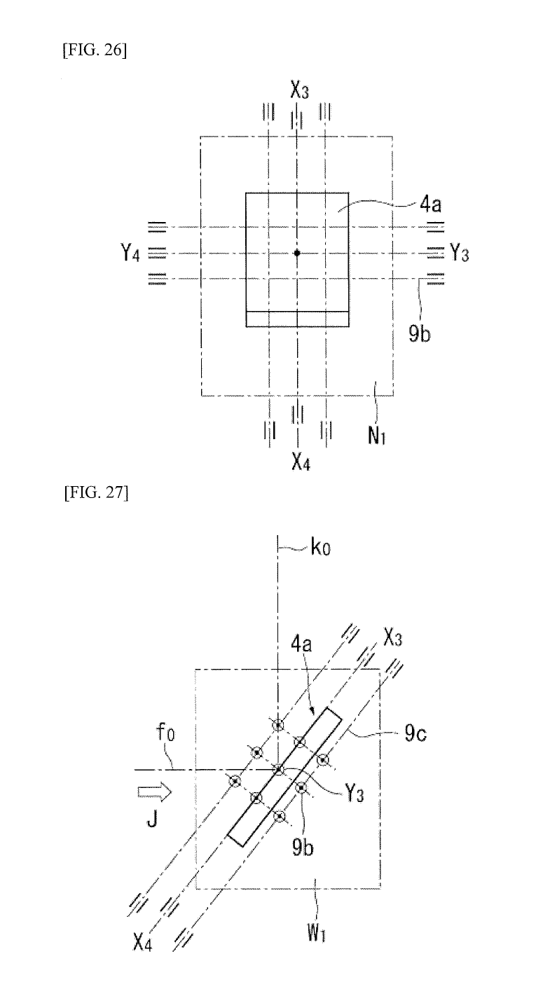

FIG. 27 shows a diagram wherein FIG. 25 is viewed from the direction of the arrow G, and FIG. 26 is an ancillary drawing from the direction of the arrow J in FIG. 27. FIG. 27 is a surface parallel to the spatial plane Wᵢ.

In FIG. 27, the X₃-X₄ axis appears as illustrated in the figure. Given this, the Y₃-Y₄ axis is perpendicular to the plane of the paper, and exists at the intersection of the optical axes k₀ and f₀.

In contrast, the axis 9b, illustrated in FIG. 7 and FIG. 8, is an axis parallel to the X₃-X₄ axis, and is an axis that exists in the spatial plane W₁. On the other hand, the axis 9c illustrated in FIG. 7 and FIG. 8 is an axis parallel to the Y₃-Y₄ axis, and is located away from the spatial plane N₁.

In this way, for example, if the rotational axis of the dichroic mirror 4 is an axis parallel to the X₃-X₄ axis, then the position of the mirror surface 4a will be different when the dichroic mirror 4 is rotated, but the angle of the mirror surface will be the same as the angle of rotation of the rotational axis. This is the angle, not the position of the mirror, and thus insofar as it is parallel to the X₃-X₄ axis, the axis of rotation need not be on the mirror surface 4a. The same is true regarding Y₃-Y₄. To illustrate this, as an alternate example of the axes of rotation, coordinate axes having nine origins that include the X₃-X₄ axis and the Y₃-Y₄ axis are illustrated in FIG. 26 and FIG. 27.

It is better for the X₃-X₄ axis and the Y₃-Y₄ axis to be oriented as illustrated in the figure, this need not necessarily be the orientation. For example, it may instead be the X₂₀-X₂₁ axis, illustrated in FIG. 25, and the Y₂₀-Y₂₁ axis perpendicular thereto. That is, the adjustment will be possible as long as there is an adjusting mechanism wherein the dichroic mirror 4 can be rotated on two mutually perpendicular axes.

While in the explanations thus far the explanations have been for two axes that are in the same space, the adjustments are still possible even if they are in different spaces. For example, the adjusting mechanism may be one wherein the X₃-X₄ axis and axis 9b are used as the axes of rotation.

Moreover, it need not necessarily be an adjusting mechanism wherein the two axes are moved independently, but rather, as illustrated in FIG. 7 and FIG. 8, the structure may be a spherical shape centered on the intersection of the two axes (9b and 9c).

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

### EXPLANATION OF CODES

1: Laser Projector

2 (2a through 2c): Laser Diodes (LDs)

3 (3a through 3c): Lenses

4 (4a through 4c): Dichroic Mirrors

5 (5a and 5b): Prisms

6: Aperture

7: Reflecting Mirror

8: Scanning Mirror

9 (9a through 9c): Mirror Holders

10: Housing

21: Laser Projector

22 (22a through 22c): Laser Diodes (LDs)

23 (23a through 23c): Lenses

24 (24a through 24c): Dichroic Mirrors

25 (25a and 25b): Prisms

26: Aperture

27: Reflecting Mirror

28: Scanning Mirror

29 (9a through 9c): LD Holders

30: Housing

What is claimed is:

1. An image projecting device comprising:
a light-emitting element that emits a laser beam and is secured to a housing; and
a mirror element adjustably disposed on the housing and that reflects the laser beam emitted from the light-emitting element to be directed to a position that has been determined to be a focusing target, wherein
the mirror element is adjustable while being disposed on the housing.

2. The image displaying device as set forth in claim 1, wherein
the mirror element is rotatable around a major axis of an ellipse that forms a spot shape of the laser beam on a mirror surface.

3. The image displaying device as set forth in claim 1, wherein
the mirror element is rotatable around a minor axis of an ellipse that forms a spot shape of the laser beam on a mirror surface.

4. The image displaying device as set forth in claim 1, wherein
the mirror element is shiftable in a direction that changes a length of an optical path from the light-emitting element.

5. The image displaying device as set forth in claim 1, further comprising:
a plurality of light-emitting elements and a plurality of mirror elements, wherein
the plurality of light-emitting elements are arranged lined up in a direction parallel to major axes of ellipses that form the spot shapes of laser beams emitted from each of the plurality of light-emitting elements, and
the plurality of mirror elements are disposed lined up corresponding to the plurality of light-emitting elements.

6. The image displaying device as set forth in claim 2, wherein
the mirror element is rotatable around a minor axis of an ellipse that forms a spot shape of the laser beam on the mirror surface.

7. The image displaying device as set forth in claim 2, wherein
the mirror element is shiftable in a direction that changes a length of an optical path from the light-emitting element.

8. The image displaying device as set forth in claim 3, wherein
the mirror element is shiftable in a direction that changes a length of an optical path from the light-emitting element.

9. The image displaying device as set forth in claim 2, further comprising:
a plurality of light-emitting elements and a plurality of mirror elements, wherein
the plurality of light-emitting elements are arranged lined up in a direction parallel to major axes of ellipses that form the spot shapes of laser beams emitted from each of the plurality of light-emitting elements, and
the plurality of mirror elements are disposed lined up corresponding to the plurality of light-emitting elements.

10. The image displaying devices as set forth in claim 3, further comprising:
a plurality of light-emitting elements and a plurality of mirror elements, wherein
the plurality of light-emitting elements are arranged lined up in a direction parallel to major axes of ellipses that form the spot shapes of laser beams emitted from each of the plurality of light-emitting elements, and
the plurality of mirror elements are disposed lined up corresponding to the plurality of light-emitting elements.

11. The image displaying device as set forth in claim 4, further comprising:
a plurality of light-emitting elements and a plurality of mirror elements, wherein
the plurality of light-emitting elements are arranged lined up in a direction parallel to major axes of ellipses that form the spot shapes of laser beams emitted from each of the plurality of light-emitting elements, and
the plurality of mirror elements are disposed lined up corresponding to the plurality of light-emitting elements.

12. An image projecting method comprising:
emitting a laser beam from a light-emitting element secured to a housing;
reflecting the laser beam emitted from the light-emitting element to be directed to a position that has been determined to be a focusing target; and
disposing a mirror element on the housing such that the mirror element is adjustable while being disposed on the housing.

13. The image displaying method as set forth in claim 12, wherein
disposing the mirror element on the housing to be rotatable around a major axis of an ellipse that forms a spot shape of the laser beam on a mirror surface.

14. The image displaying method as set forth in claim 12, wherein
disposing the mirror element on the housing to be rotatable around a minor axis of an ellipse that forms a spot shape of the laser beam on a mirror surface.

15. The image displaying method as set forth in claim 12, wherein
disposing the mirror element on the housing to be shiftable in a direction that changes a length of an optical path from the light-emitting element.

16. The image displaying method as set forth in claim 12, further comprising:
arranging on the housing a plurality of light-emitting elements lined up in a direction parallel to major axes of ellipses that form the spot shapes of laser beams emitted from each of the plurality of light-emitting elements; and
arranging on the housing a plurality of mirror elements lined up to correspond to the plurality of light-emitting elements.
